(19) United States
(12) Patent Application Publication
(10) Pub. No.: US 2022/0341898 A1
(43) Pub. Date: Oct. 27, 2022

(54) LC Issue Diagnosis from Pressure Trace Using Machine Learning

(71) Applicant: DH TECHNOLOGIES DEVELOPMENT PTE. LTD., Singapore (SG)

(72) Inventors: David Michael Cox, Concord (CA); Yves Le Blanc, Newmarket (CA)

(21) Appl. No.: 17/753,034

(22) PCT Filed: Aug. 14, 2020
(86) PCT No.: PCT/IB2020/057687

§ 371 Date: Feb. 16, 2022

Related U.S. Application Data
(60) Provisional application No. 62/889,421, filed on Aug. 20, 2019.

(51) Int. Cl. G01N 30/86

(52) U.S. Cl. CPC G01N 30/86; G01N 30/7233

(57) ABSTRACT

An operational condition of a liquid chromatography (LC) system (2110) is detected and displayed without user intervention. A plurality of pressure measurements over time are received from a pressure sensor (2119) of the LC system. A processor (2140) calculates values from the measurements for six parameters including a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B}. The values of the six parameters are classified as one of one or more operational conditions of the LC system using a machine learning model. The machine learning model is created from values of the six parameters calculated from known separations for each of the one or more operational conditions. The operational condition found from the classification is displayed on a display device (2141).

### RELATED APPLICATIONS

This application claims the benefit of U.S. Provisional Patent Application Ser. No. 62/889,421, filed on Aug. 20, 2019, the content of which is incorporated by reference herein in its entirety.

### INTRODUCTION

The teachings herein relate to liquid chromatography (LC) system and LC coupled mass spectrometry (LC-MS) apparatus for detecting and displaying an operational condition of an LC system without user intervention. More specifically, using LC system apparatus, values for one or more of six parameters of LC column pressure measurements are obtained from a pressure sensor of the LC system and are classified as an operational condition of the LC system using a machine learning model. The six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B}. Using LC-MS system apparatus, values for one or more of six parameters of extracted ion chromatograms (XICs) of one or more LC solvents are obtained from a mass spectrometer of an LC-MS system and are classified as an operational condition of the LC system using a machine learning model. The six parameters include a beginning intensity (I_{B}), an ending intensity (I_{E}), an average Intensity (T₁) for a first half of the separation, an average intensity (T₂) for a second half of the separation, a ratio T₁/I_{B}, and a ratio T₂/I_{B}.

The apparatus and methods disclosed herein can be performed in conjunction with a processor, controller, microcontroller, or computer system, such as the computer system of FIG. 1.

### Liquid Chromatography System Setup Issues

Liquid chromatography (LC) is a well-known technique used to separate and analyze compounds from a sample mixture. Generally, in an LC system, a solvent is added to the sample mixture producing a mobile phase solution. The mobile phase solution is then passed through an LC column (filter) containing an adsorbent to separate compounds of interest from the sample mixture over time.

Low-pressure LC typically uses the force of gravity to pass the mobile phase solution through the LC column. In high-performance liquid chromatography (HPLC), pumps are used to pass the mobile phase solution through the LC column at a higher pressure (50-350 bar or 725-5000 pound-force per square inch (psi), or higher). Current off-the-shelf pumps provide pressures close to 20,000 psi, for example.

Many problems that occur in LC experiments can be traced back to LC equipment setup issues. LC equipment setup issues can include, but are not limited to, empty solvent bottles, reversed solvent bottles, fitting failures, and air injection during sample injection. These setup issues seem trivial once they are detected but often take many hours to diagnose even by LC experts. Also, the diagnosis of these setup issues sometimes requires the additional consumption of precious samples.

One method to avoid LC equipment setup issues has been to require a user to enter the amount and type of solvent placed in each solvent bottle before each experiment. Unfortunately, however, users often see such methods as prone to error and as requiring unnecessary extra effort. Consequently, most users ignore these methods or turn them off.

As a result, additional apparatus and methods are needed to identify LC equipment setup issues quickly, without consuming additional sample, and without additional user intervention.

### Liquid Chromatography System Background

FIG. 2 is an exemplary diagram 200 of an LC system. In FIG. 2 the LC system is a high-performance liquid chromatography (HPLC) device 210. In HPLC device 210, one of two solvents 211 or 212 is selected using valve 215. For example, solvent 211 can be the low organic solvent (between 0 and 30%), and solvent 212 can be the high organic solvent (between 70 and 100%).

Solvents 211 or 212 are moved to valve 215 using pumps 213 and 214, respectively. Sample 216 is selected using autosampler 219, for example. Sample 216 is mixed with the selected solvent using mixer 217, and the resulting mobile phase solution is sent through liquid chromatography (LC) column 218.

The separated mobile phase solution is then sent from valve 230 to a detector. The detector can include, but is not limited to, a mass spectrometer (not shown). Mobile phase additives (not shown), such as formic acid, acetic acid, ammonium formate, and others, can also be added to the mixture of HPLC device 210 before LC column 218, for example.

### Mass Spectrometry Background

Mass spectrometry (MS) is an analytical technique for detection and quantitation of chemical compounds based on the analysis of m/z values of ions formed from those compounds. MS involves ionization of one or more compounds of interest from a sample, producing precursor ions, and mass analysis of the precursor ions.

Tandem mass spectrometry or mass spectrometry/mass spectrometry (MS/MS) involves ionization of one or more compounds of interest from a sample, selection of one or more precursor ions of the one or more compounds, fragmentation of the one or more precursor ions into product ions, and mass analysis of the product ions.

Both MS and MS/MS can provide qualitative and quantitative information. The measured precursor or product ion spectrum can be used to identify a molecule of interest. The intensities of precursor ions and product ions can also be used to quantitate the amount of the compound present in a sample.

Tandem mass spectrometry can be performed using many different types of scan modes. For example, quadrupole tandem mass spectrometers can typically perform a product ion scan, a neutral loss scan, a precursor ion scan, and a selected reaction monitoring (SRM) or a multiple reaction monitoring (MRM) scan.

A product ion scan typically follows the MS/MS method described above. A collection of precursor ions is selected by a quadrupole mass filter. Each of the precursor ions of the collection is fragmented in a quadrupole collision cell. All of the resulting product ions for each precursor ion are then selected and mass analyzed using a quadrupole mass analyzer, producing a product ion spectrum for each precursor ion. A product ion scan is used, for example, to identify all of the products of a particular precursor ion.

In a neutral loss scan, a collection of precursor ions is also selected by a quadrupole mass filter, and each of the precursor ions of the collection is fragmented in a quadrupole collision cell. However, in a neutral loss scan, only product ions that differ in mass-to-charge ratio (m/z) value from their precursor ion by the neutral loss value are selected and mass analyzed using a quadrupole mass analyzer, producing for each precursor ion an intensity for a product ion that differs in m/z value from the precursor ion by the neutral loss. A neutral loss scan is used, for example, to confirm the presence of a precursor ion or, more commonly, to identify compounds sharing a common neutral loss.

In a precursor ion scan, a collection of precursor ions is also selected by a quadrupole mass filter, and each of the precursor ions of the collection is fragmented in a quadrupole collision cell. However, in a precursor ion scan, only an m/z value of a specific product ion is selected and mass analyzed using a quadrupole mass analyzer, producing an intensity for a specific product ion for each precursor ion. A precursor ion scan is used, for example, to confirm the presence of a precursor ion or, more commonly, to identify compounds sharing a common product ion.

In an SRM or MRM scan, at least one precursor ion and product ion pair is known in advance. The quadrupole mass filter then selects the one precursor ion. The quadrupole collision cell fragments the precursor ion. However, only product ions with the m/z of the product ion of the precursor ion and product ion pair are selected and mass analyzed using a quadrupole mass analyzer, producing an intensity for the product ion of the precursor ion and product ion pair. In other words, only one product ion is monitored. An SRM or MRM scan is used, for example, primarily for quantitation.

### SUMMARY

An apparatus, method, and computer program product are disclosed for an LC system for detecting and displaying an operational condition of the LC system without user intervention. The apparatus includes an LC column of the LC system, a pressure sensor, a display device, and a processor.

An LC column of the LC system receives a mobile phase solution and performs a separation of one or more compounds from a sample in a mobile phase solution over time. A pressure sensor of the LC system measures a pressure of the mobile phase solution in the LC column over time, producing a plurality of pressure measurements over time. For example, the pressure is measured from an aqueous channel.

In other embodiments, the pressure is measured from an organics mobile phase channel. For example, the pressure is measured during an isocratic injection.

A processor receives the plurality of pressure measurements over time from the pressure sensor. The processor calculates values for one or more of six parameters from the plurality of pressure measurements over time. The six parameters include P_{B}, P_{E}, T₁, T₂, T₁/P_{B}, and T₂/P_{B}. The processor classifies the values of one or more of the six parameters as one of one or more operational conditions of the LC system using a machine learning model. The one or more operational conditions of the LC system can include, but are not limited to, normal operation with no LC equipment setup issues, an empty solvent bottle A, an empty solvent bottle B, reversed bottles A and B, a fitting failure, and air injected during sample injection.

Finally, the processor displays on a display device an indicator of the classification of the values as one of the one or more operational conditions.

An apparatus, method, and computer program product are disclosed for an LC-MS system for detecting and displaying an operational condition of the LC system of the LC-MS system without user intervention. The apparatus includes an LC column of the LC system, a mass spectrometer, a display device, and a processor.

An LC column of the LC system receives a mobile phase solution and performs a separation of one or more compounds from a sample in a mobile phase solution over time. The mass spectrometer measures intensities for at least one solvent composition of the LC system over time, producing at least one extracted ion chromatogram (XIC) for the at least one solvent composition.

A processor receives the at least one XIC from the mass spectrometer. The processor calculates values for one or more of six parameters from the one or more XICs. The six parameters include I_{B}, I_{E}, A₁, A₂, A₁/I_{B}, and A₂/P_{B}. The processor classifies the values of one or more of the six parameters as one of one or more operational conditions of the LC system using a machine learning model. The one or more operational conditions of the LC system can include, but are not limited to, normal operation with no LC equipment setup issues, an empty solvent bottle A, an empty solvent bottle B, reversed bottles A and B, a fitting failure, and air injected during sample injection.

Finally, the processor displays on a display device an indicator of the classification of the values as one of the one or more operational conditions.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram of a liquid chromatography (LC) system.

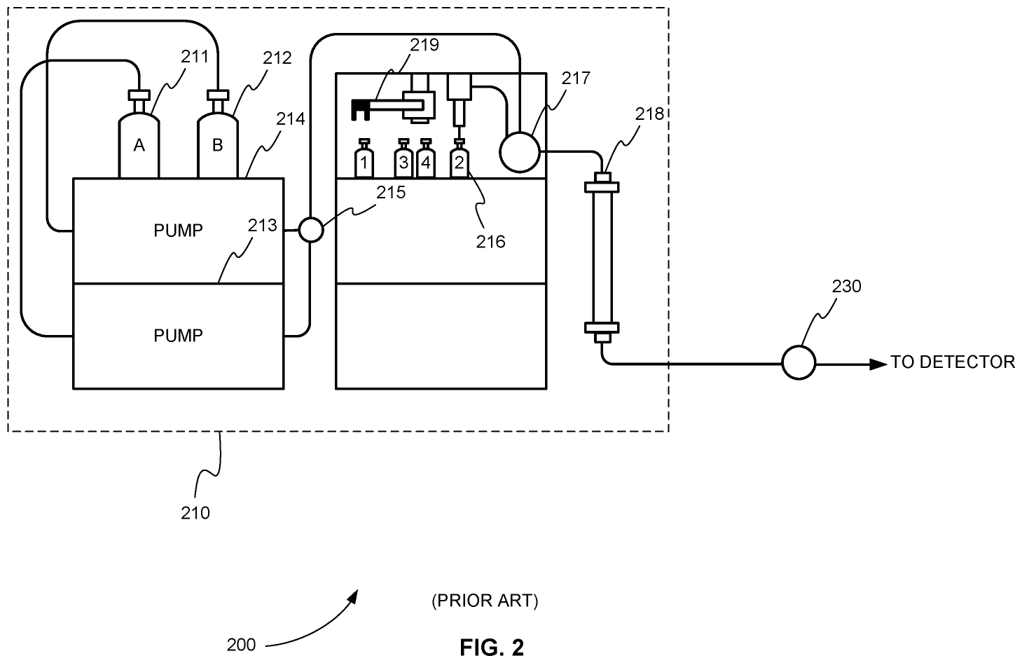

FIG. 3 is an exemplary plot of an extracted ion chromatogram (XIC) produced by a liquid chromatography mass spectrometry/mass spectrometry (LC-MS/MS) experiment in which the operational condition of the LC system was normal operation and the solvent used in the LC system was methanol, in accordance with various embodiments.

FIG. 4 is an exemplary plot of a pressure trace produced during the LC-MS/MS experiment of FIG. 3 in which the operational condition of the LC system was normal operation and the solvent used in the LC system was methanol, in accordance with various embodiments.

FIG. 5 is an exemplary plot of an XIC produced by an LC-MS/MS experiment in which the operational condition of the LC system was an empty bottle A and the solvent used in the LC system was methanol, in accordance with various embodiments.

FIG. 6 is an exemplary plot of a pressure trace produced during the LC-MS/MS experiment of FIG. 5 in which the operational condition of the LC system was an empty bottle A and the solvent used in the LC system was methanol, in accordance with various embodiments.

FIG. 7 is an exemplary plot of an XIC produced by an LC-MS/MS experiment in which the operational condition of the LC system was an empty bottle B and the solvent used in the LC system was methanol, in accordance with various embodiments.

FIG. 8 is an exemplary plot of a pressure trace produced during the LC-MS/MS experiment of FIG. 7 in which the operational condition of the LC system was an empty bottle B and the solvent used in the LC system was methanol, in accordance with various embodiments.

FIG. 9 is an exemplary plot of an XIC produced by an LC-MS/MS experiment in which the operational condition of the LC system was reversed bottles A and B and the solvent used in the LC system was methanol, in accordance with various embodiments.

FIG. 10 is an exemplary plot of a pressure trace produced during the LC-MS/MS experiment of FIG. 9 in which the operational condition of the LC system was reversed bottles A and B and the solvent used in the LC system was methanol, in accordance with various embodiments.

FIG. 11 is an exemplary plot of an XIC produced by an LC-MS/MS experiment in which the operational condition of the LC system was normal operation and the solvent used in the LC system was acetonitrile, in accordance with various embodiments.

FIG. 12 is an exemplary plot of a pressure trace produced during the LC-MS/MS experiment of FIG. 11 in which the operational condition of the LC system was normal operation and the solvent used in the LC system was acetonitrile, in accordance with various embodiments.

FIG. 13 is an exemplary plot of an XIC produced by an LC-MS/MS experiment in which the operational condition of the LC system was air injected during sample injection and the solvent used in the LC system was acetonitrile, in accordance with various embodiments.

FIG. 14 is an exemplary plot of a pressure trace produced during the LC-MS/MS experiment of FIG. 13 in which the operational condition of the LC system was air injected during sample injection and the solvent used in the LC system was acetonitrile, in accordance with various embodiments.

FIG. 15 is an exemplary plot of a pressure trace produced during an LC-MS/MS experiment in which the operational condition of the LC system was normal operation, the solvent used in the LC system was acetonitrile, and the pressure measured was a pump pressure, in accordance with various embodiments.

FIG. 16 is an exemplary plot of a pressure trace produced during an LC-MS/MS experiment in which the operational condition of the LC system was a fitting failure, the solvent used in the LC system was acetonitrile, and the pressure measured was a pump pressure, in accordance with various embodiments.

FIG. 17 is an exemplary plot showing how threshold values are found for two measurement parameters using values for the two measurement parameters obtained from pressure traces measured from separations performed under different known operational conditions, in accordance with various embodiments.

FIG. 18 is an exemplary diagram showing how a machine learning model is created and used, in accordance with various embodiments.

FIG. 19 is an exemplary plot of a pressure trace produced during an LC-MS/MS experiment in which the operational condition of the LC system was determined using a machine learning model, in accordance with various embodiments.

FIG. 20 is an exemplary display window of a display device showing the operational conditions found for the five pressure traces of FIG. 19, in accordance with various embodiments.

FIG. 21 is a schematic diagram of apparatus for detecting and displaying an operational condition of an LC system without user intervention, in accordance with various embodiments.

FIG. 22 is a flowchart showing a method for detecting and displaying an operational condition of an LC system without user intervention, in accordance with various embodiments.

FIG. 23 is a schematic diagram of a system that includes one or more distinct software modules that perform a method for detecting and displaying an operational condition of an LC system without user intervention, in accordance with various embodiments.

FIG. 24 is a schematic diagram of apparatus for detecting and displaying an operational condition of an LC system of an LC-MS system without user intervention, in accordance with various embodiments.

FIG. 25 is a flowchart showing a method for detecting and displaying an operational condition of an LC system of an LC-MS system without user intervention, in accordance with various embodiments.

FIG. 26 is a schematic diagram of system that includes one or more distinct software modules that perform a method for detecting and displaying an operational condition of an LC system of an LC-MS system without user intervention, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

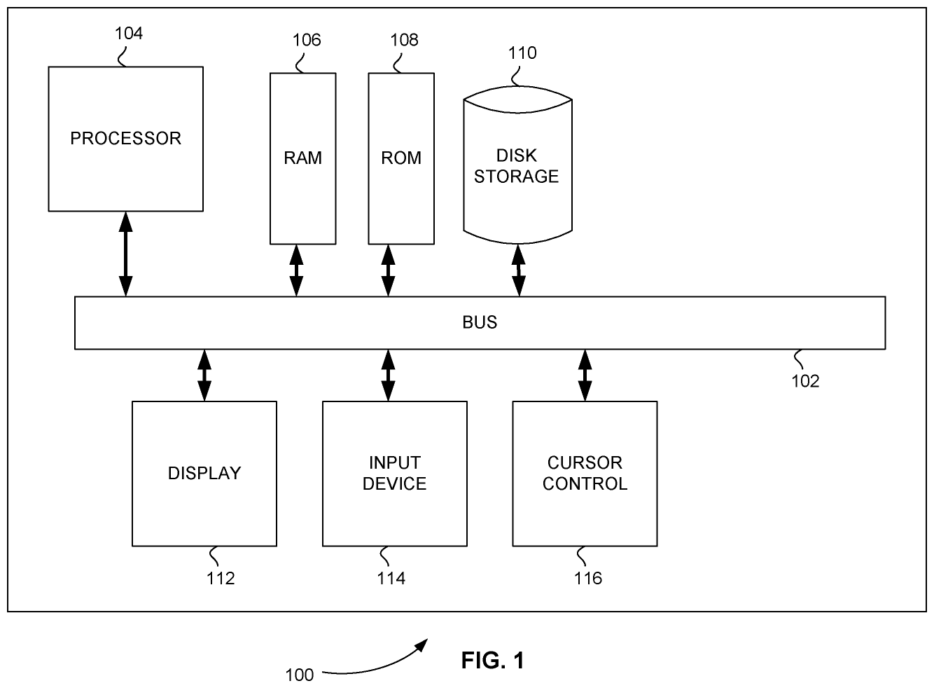

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Apparatus and Methods to Identify LC Equipment Setup Issues

As described above, many problems that occur in LC experiments can be traced back to LC equipment setup issues. LC equipment setup issues can include, but are not limited to, empty solvent bottles, reversed solvent bottles, fitting failures, and air injection during sample injection. These setup issues seem trivial once they are detected but often take many hours to diagnose even by LC experts. Also, the diagnosis of these setup issues sometimes requires the additional consumption of precious samples.

One method to avoid LC equipment setup issues has been to require a user to enter the amount and type of solvent placed in each solvent bottle before each experiment. Unfortunately, however, users often see such methods as prone to error and as requiring unnecessary extra effort. Consequently, most users ignore these methods or turn them off.

As a result, additional apparatus and methods are needed to identify LC equipment setup issues quickly, without consuming additional sample, and without additional user intervention.

In various embodiments, apparatus is provided for detecting and displaying the operational condition of an LC system without user intervention. The apparatus includes an LC column, a pressure sensor, a display device, and a processor. The pressure sensor measures the pressure of the mobile phase solution in the LC column during a sample separation. This produces a plurality of pressure measurements over time, which when plotted are referred to as a pressure trace.

The processor converts the pressure trace to a small number of measurement parameters. These parameters include, for example, the beginning pressure (P_{B}), the ending pressure (P_{E}), the average pressure (T₁) for a first half of the separation, the average pressure (T₂) for a second half of the separation, the ratio T₁/P_{B}, and the ratio T₂/P_{B}. Using these parameters from the pressure trace, the patterns between normal separation runs and separation runs that failed due to improper LC equipment setup issues can be objectively determined. This objective determination is performed using a machine learning classifier or manually programmed decision tree, for example.

In particular, after a separation, the processor classifies the values of one or more of the six parameters as one of one or more operational conditions using a machine learning model. The operational conditions are, for example, normal equipment operation or one or more equipment setup issues. The machine learning model is created from values of the one or more of the six parameters calculated from previous separations. These previous separations include separations where it is known that there was normal equipment operation and separations where it is known that there was each of the one or more equipment setup issues.

These previous separations can be performed by a vendor/manufacturer of an LC or mass spectrometry system. It is not an extra burden on the end user.

Finally, the processor displays on the display device an indicator of the classification of the values of one or more of the six parameters as one of one or more operational conditions. The indicator can be, but is not limited to, a description of the equipment status.

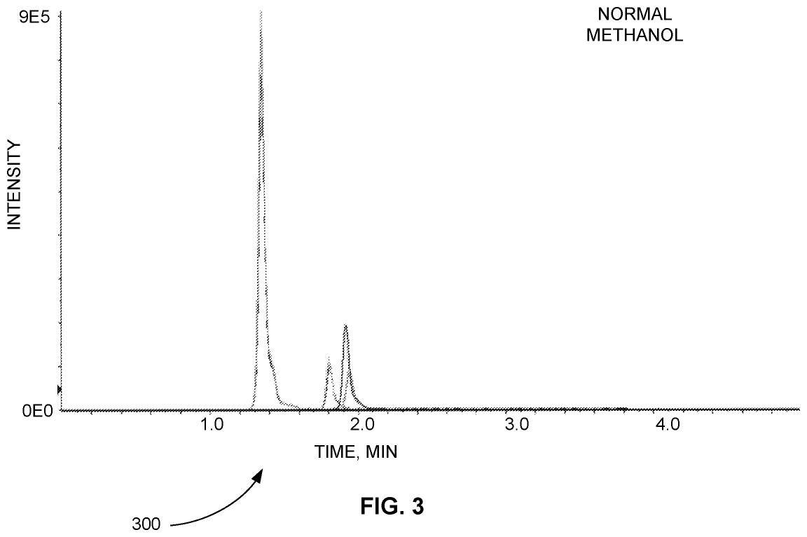

The following FIGS. 3-16 show how extracted ion chromatograms (XICs) and pressure traces are affected by different LC system operational conditions. These XICs and pressure traces were obtained using LC systems from multiple vendors. The LC systems were configured for direct column injection and ran a gradient method. At the beginning of the gradient, a low organic solvent composition (between 0 and 30%) from bottle A was used. At the end of the gradient, a high organic solvent composition (between 70 and 100%) from bottle B was used. The high organic solvent composition was held for a short period, and then the LC system was rapidly returned to the starting low organic solvent composition for enough time to re-equilibrate the column. All systems had pressure measurements that were indicative of the pressure at the head of the column.

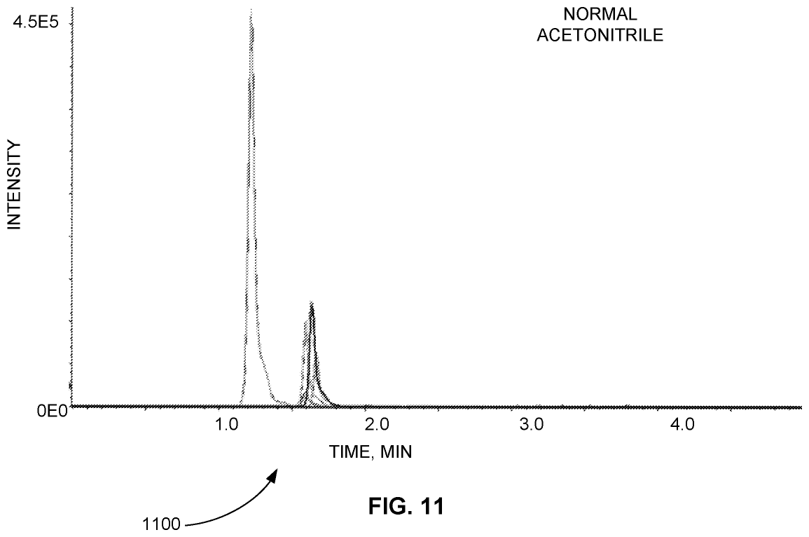

Different solvents were used to obtain the results shown in FIGS. 3-16. Methanol was used to obtain the results shown in FIGS. 3-10. Acetonitrile was used to obtain the results shown in FIGS. 11-16.

FIG. 3 is an exemplary plot 300 of an extracted ion chromatogram (XIC) produced by a liquid chromatography mass spectrometry/mass spectrometry (LC-MS/MS) experiment in which the operational condition of the liquid chromatography (LC) system was normal operation and the solvent used in the LC system was methanol, in accordance with various embodiments. FIG. 3 includes traces for four different multiple reaction monitoring (MRM) transitions monitored by the mass spectrometer for the compounds reserpine, verapamil, rescinamine, and clenbuterol, for example.

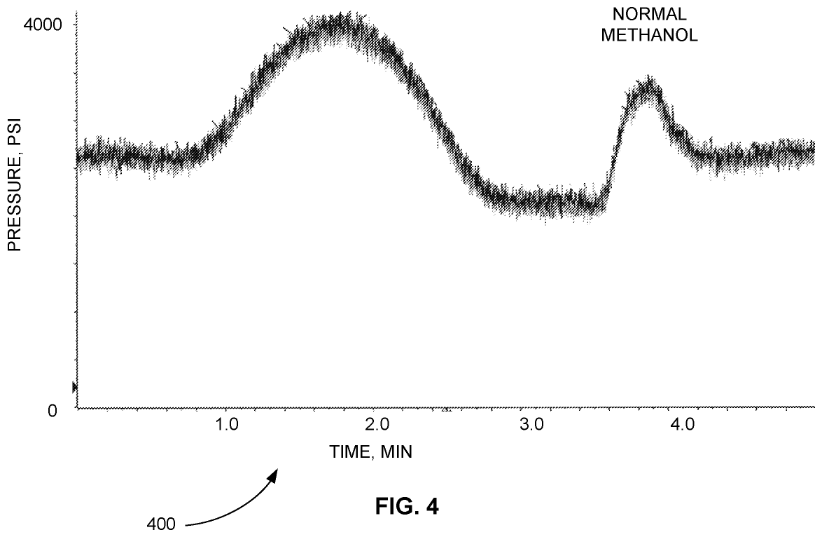

FIG. 4 is an exemplary plot 400 of a pressure trace produced during the LC-MS/MS experiment of FIG. 3 in which the operational condition of the LC system was normal operation and the solvent used in the LC system was methanol, in accordance with various embodiments. FIG. 4 is an overlay of 10 pressure traces corresponding to 10 different injections. Most simply, FIG. 4 shows the pattern of a pressure trace for a normal separation run using the solvent methanol with no LC equipment setup issues.

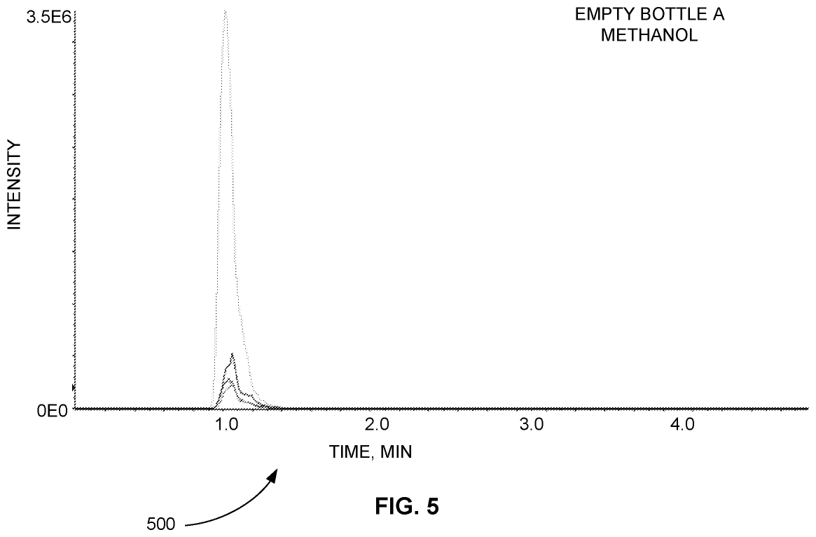

FIG. 5 is an exemplary plot 500 of an XIC produced by an LC-MS/MS experiment in which the operational condition of the LC system was an empty bottle A and the solvent used in the LC system was methanol, in accordance with various embodiments. FIG. 5 also includes traces for four different multiple reaction monitoring (MRM) transitions monitored by the mass spectrometer for the compounds reserpine, verapamil, rescinamine, and clenbuterol, for example.

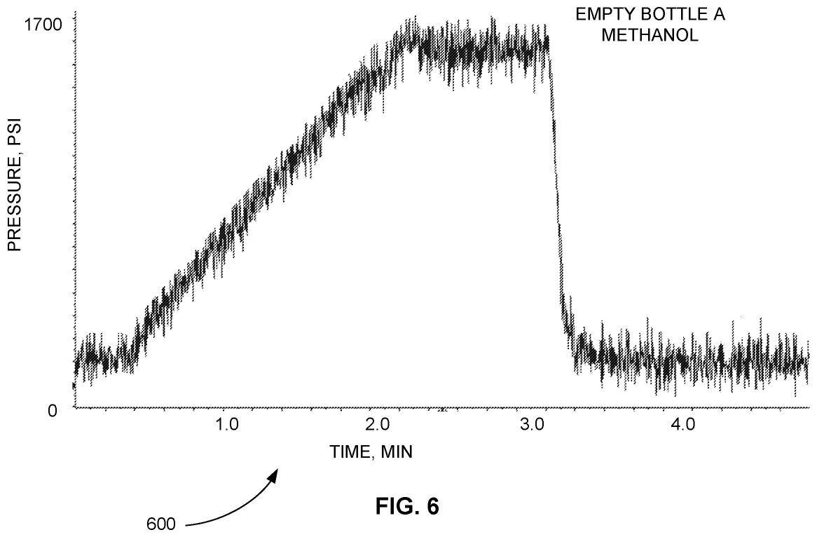

FIG. 6 is an exemplary plot 600 of a pressure trace produced during the LC-MS/MS experiment of FIG. 5 in which the operational condition of the LC system was an empty bottle A and the solvent used in the LC system was methanol, in accordance with various embodiments. FIG. 6 includes a single pressure trace corresponding to a single injection. Most simply, FIG. 6 shows the pattern of a pressure trace for an abnormal separation run where the low organic solvent bottle A was empty.

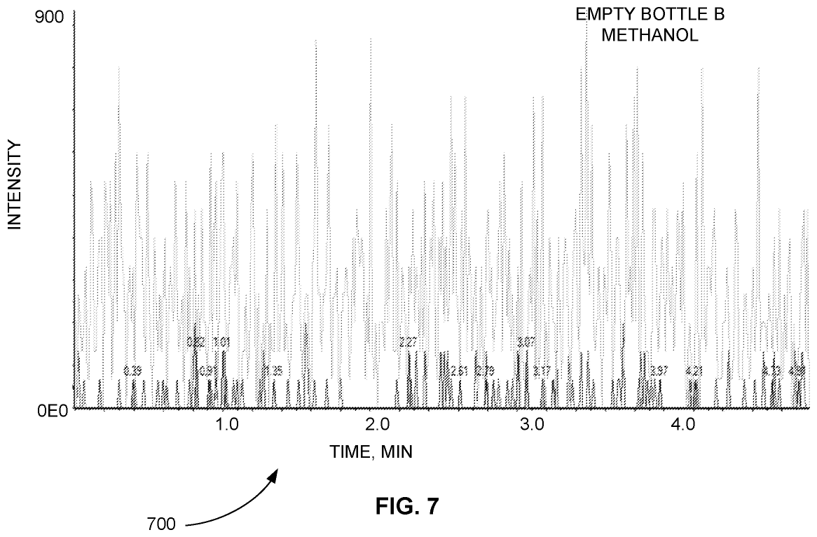

FIG. 7 is an exemplary plot 700 of an XIC produced by an LC-MS/MS experiment in which the operational condition of the LC system was an empty bottle B and the solvent used in the LC system was methanol, in accordance with various embodiments. FIG. 7 also includes traces for four different multiple reaction monitoring (MRM) transitions monitored by the mass spectrometer for the compounds reserpine, verapamil, rescinamine, and clenbuterol, for example.

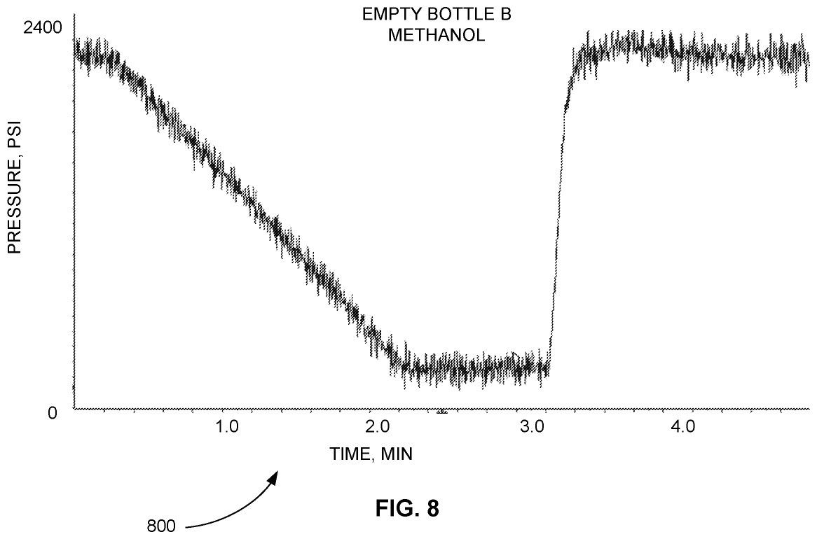

FIG. 8 is an exemplary plot 800 of a pressure trace produced during the LC-MS/MS experiment of FIG. 7 in which the operational condition of the LC system was an empty bottle B and the solvent used in the LC system was methanol, in accordance with various embodiments. FIG. 8 includes a single pressure trace corresponding to a single injection. Most simply, FIG. 8 shows the pattern of a pressure trace for an abnormal separation run where the high organic solvent bottle B was empty.

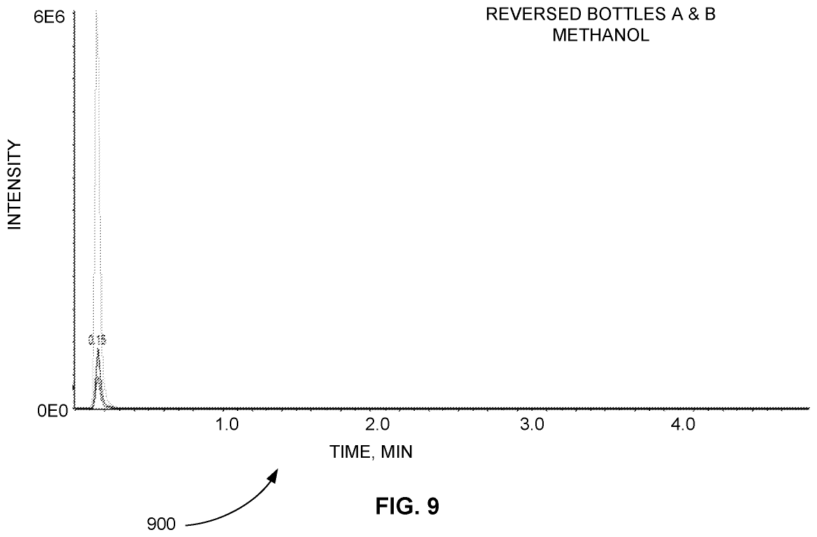

FIG. 9 is an exemplary plot 900 of an XIC produced by an LC-MS/MS experiment in which the operational condition of the LC system was reversed bottles A and B and the solvent used in the LC system was methanol, in accordance with various embodiments. FIG. 9 also includes traces for four different multiple reaction monitoring (MRM) transitions monitored by the mass spectrometer for the compounds reserpine, verapamil, rescinamine, and clenbuterol, for example.

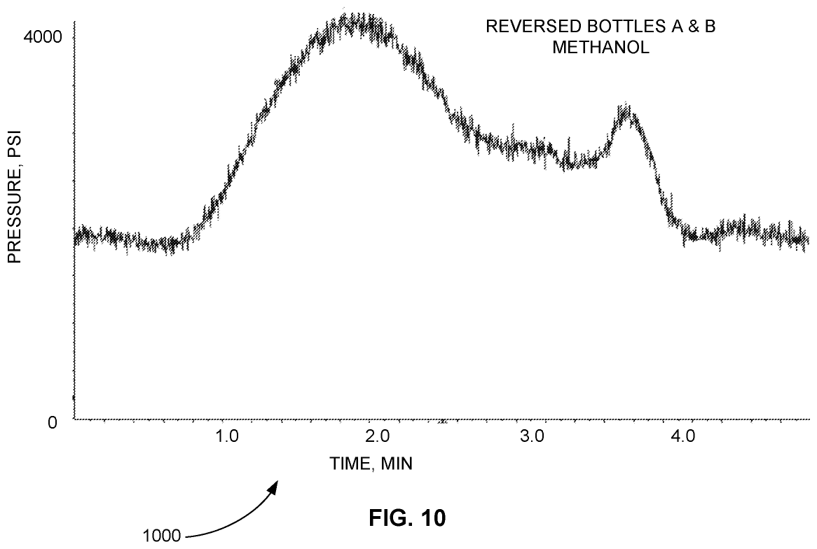

FIG. 10 is an exemplary plot 1000 of a pressure trace produced during the LC-MS/MS experiment of FIG. 9 in which the operational condition of the LC system was reversed bottles A and B and the solvent used in the LC system was methanol, in accordance with various embodiments. FIG. 10 includes a single pressure trace corresponding to a single injection. Most simply, FIG. 10 shows the pattern of a pressure trace for an abnormal separation run where the low organic solvent bottle A and the high organic solvent bottle B are reversed.

FIG. 11 is an exemplary plot 1100 of an XIC produced by an LC-MS/MS experiment in which the operational condition of the LC system was normal operation and the solvent used in the LC system was acetonitrile, in accordance with various embodiments. FIG. 11 also includes traces for four different multiple reaction monitoring (MRM) transitions monitored by the mass spectrometer for the compounds reserpine, verapamil, rescinamine, and clenbuterol, for example.

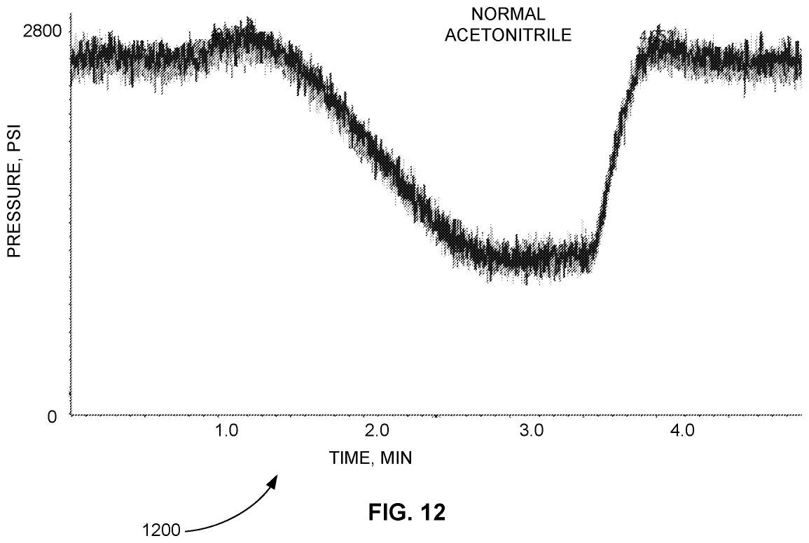

FIG. 12 is an exemplary plot 1200 of a pressure trace produced during the LC-MS/MS experiment of FIG. 11 in which the operational condition of the LC system was normal operation and the solvent used in the LC system was acetonitrile, in accordance with various embodiments. FIG. 12 includes traces for four different multiple reaction monitoring (MRM) transitions monitored by the mass spectrometer for the compounds reserpine, verapamil, rescinamine, and clenbuterol, for example. Most simply, FIG. 12 shows the pattern of a pressure trace for a normal separation run using the solvent acetonitrile with no LC equipment setup issues.

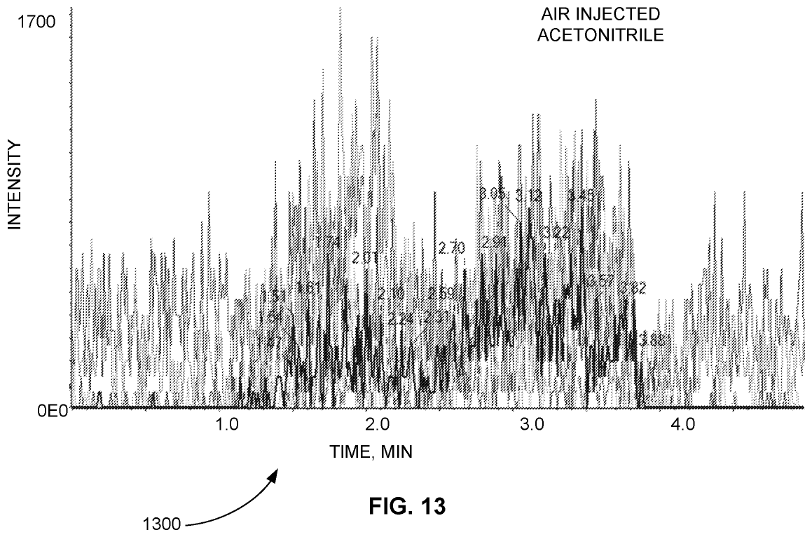

FIG. 13 is an exemplary plot 1300 of an XIC produced by an LC-MS/MS experiment in which the operational condition of the LC system was air injected during sample injection and the solvent used in the LC system was acetonitrile, in accordance with various embodiments. FIG. 13 also includes traces for four different multiple reaction monitoring (MRM) transitions monitored by the mass spectrometer for the compounds reserpine, verapamil, rescinamine, and clenbuterol, for example.

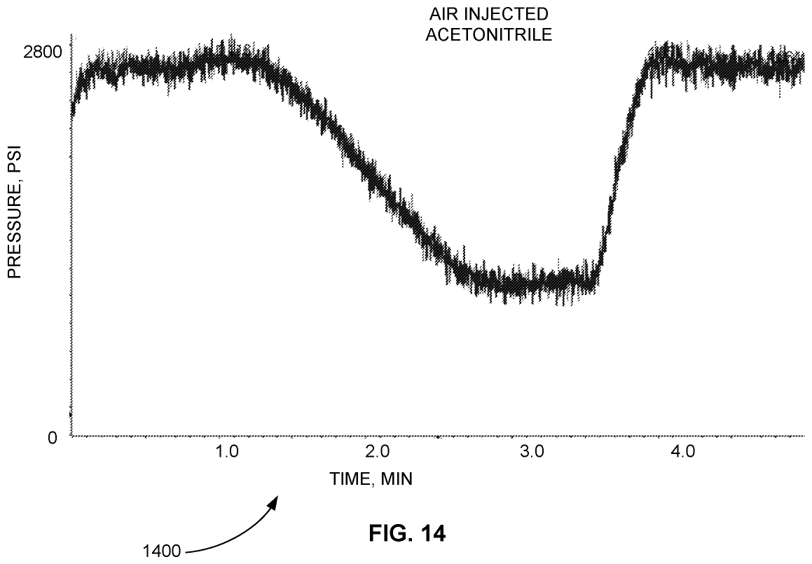

FIG. 14 is an exemplary plot 1400 of a pressure trace produced during the LC-MS/MS experiment of FIG. 13 in which the operational condition of the LC system was air injected during sample injection and the solvent used in the LC system was acetonitrile, in accordance with various embodiments. FIG. 14 includes traces for 10 pressure traces corresponding to 10 different injections. Most simply, FIG. 14 shows the pattern of a pressure trace for an abnormal separation run where air was injected during the sample injection.

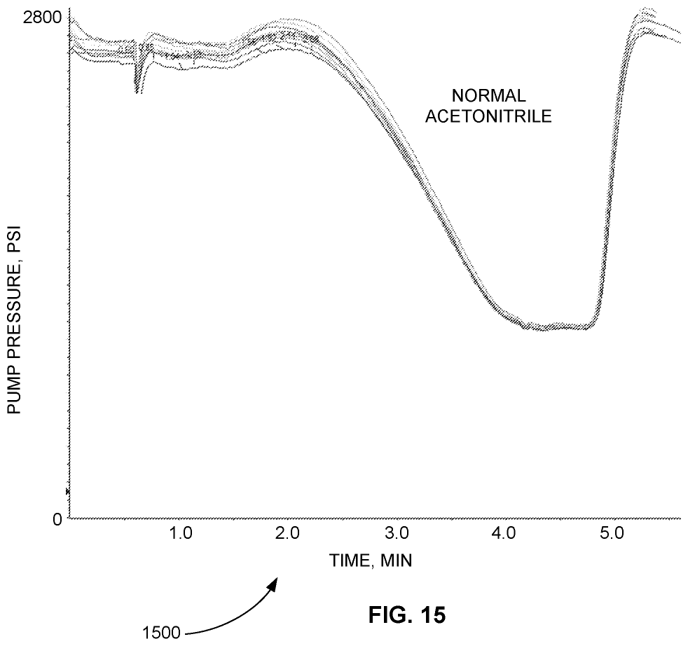

FIG. 15 is an exemplary plot 1500 of a pressure trace produced during an LC-MS/MS experiment in which the operational condition of the LC system was normal operation, the solvent used in the LC system was acetonitrile, and the pressure measured was a pump pressure, in accordance with various embodiments. FIG. 15 includes a number of different pressure traces corresponding to different compound measurements, for example. Most simply, FIG. 15 shows again the pattern of a pressure trace for a normal separation run using the solvent acetonitrile with no LC equipment setup issues. The only difference between FIG. 15 and FIG. 12 is the type of LC system used and the location of pressure measurement.

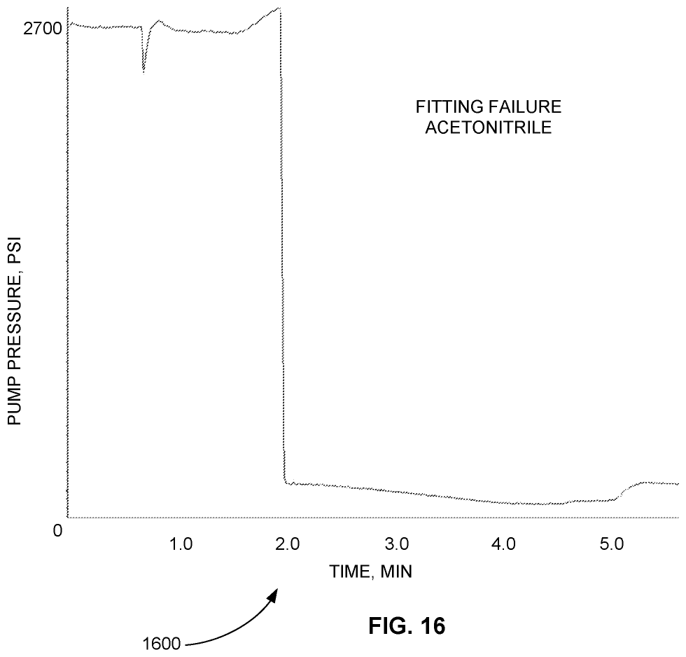

FIG. 16 is an exemplary plot 1600 of a pressure trace produced during an LC-MS/MS experiment in which the operational condition of the LC system was a fitting failure, the solvent used in the LC system was acetonitrile, and the pressure measured was a pump pressure, in accordance with various embodiments. Most simply, FIG. 16 shows the pattern of a pressure trace for an abnormal separation run where there is a fitting failure before the LC column. The trace shown in FIG. 16 is produced using the same type of LC system and location of pressure measurement as used to produce the trace shown in FIG. 15.

A comparison of FIG. 3 with FIGS. 5, 7, and 9 and a comparison of FIG. 11 with FIG. 13 shows how XICs are affected by different LC equipment setup issues. A comparison of FIGS. 4, 6, 8, 10, 12, 14, 15, and 16 shows that the pattern of the pressure trace changes for different operational conditions. Finally, a comparison of FIGS. 4 and 12 shows that the pattern of the pressure trace also changes for different solvents.

For some time, LC users have known that the pressure trace changes for different operational conditions of the LC system. LC users have also subjectively analyzed the pressure trace to help diagnose separation problems. However, to date, no one has been able to objectively classify the pressure trace changes for different operational conditions.

In various embodiments, the use of measurement parameters from the pressure trace allows the pressure trace changes to be identified. More specifically, threshold values for these measurement parameters allow the pressure trace changes to be separated into different classes that can be associated with different operational conditions. As described above, these measurement parameters include, for example, P_{B}, P_{E}, T₁, T₂, T₁/P_{B}, and T₂/P_{B}.

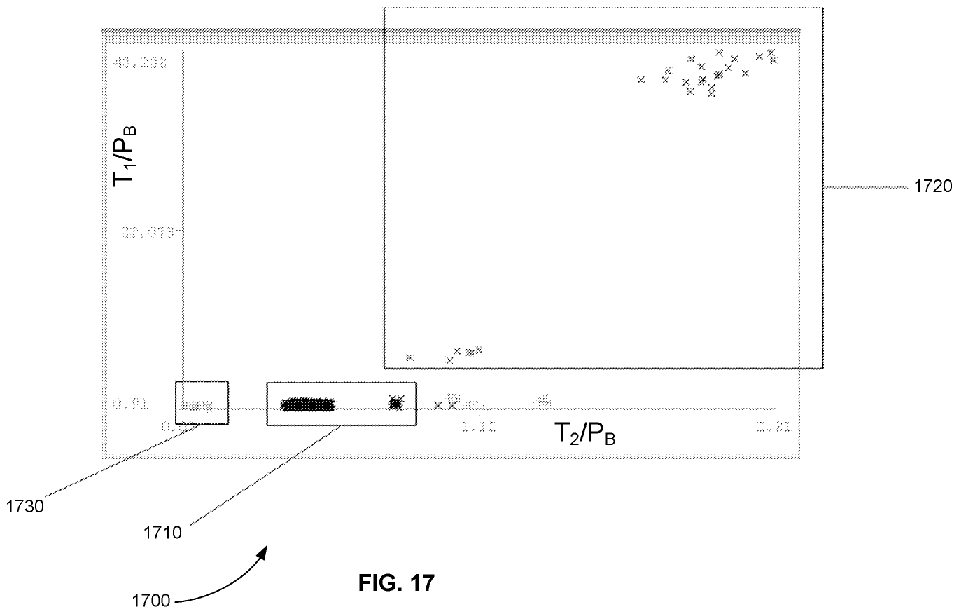

FIG. 17 is an exemplary plot 1700 showing how threshold values are found for two measurement parameters using values for the two measurement parameters obtained from pressure traces measured from separations performed under different known operational conditions, in accordance with various embodiments. In FIG. 17, the value of measurement parameter T₁/P_{B} is plotted as a function of the value measurement parameter T₂/P_{B} for the pressure traces measured from separations performed under different known operational conditions.

Points 1710 are from separations performed under normal conditions. Points 1720 are from separations performed with an empty bottle A, and points 1730 are from separations performed with an empty bottle B. From the groupings of points 1710, 1720, and 1730, threshold values for measurement parameters T₁/P_{B} and T₂/P_{B} for three different operational conditions can be found.

In various embodiments, a machine learning algorithm is used to choose threshold values for the measurement parameters that correspond to different operational conditions for the LC system. Wikipedia, for example, as of July 2018, defines machine learning as “a subset of artificial intelligence in the field of computer science that often uses statistical techniques to give computers the ability to “learn ” (i.e., progressively improve performance on a specific task) with data, without being explicitly programmed.

The machine learning algorithm used is, for example, a support vector machine or a decision tree, including a simple if-then decision tree. The machine learning algorithm chooses the threshold values corresponding to different operational conditions by comparing measurement parameters obtained from a data set of separation runs known to have all of the different operational conditions. For example, measurement parameters from separation runs represented by the pressure traces in FIGS. 4, 6, 8, 10, 14, and 16, are used to find the threshold values corresponding to normal operation, an empty bottle A, an empty bottle B, reserved bottles A and B, air injected with a sample injection, and a fitting failure, respectively.

The machine learning algorithm creates a machine learning model that includes all of the threshold values for the different operational conditions. The machine learning model is then used to determine the operational condition of any separation run based on the measurement parameters calculated from the pressure trace of the separation run.

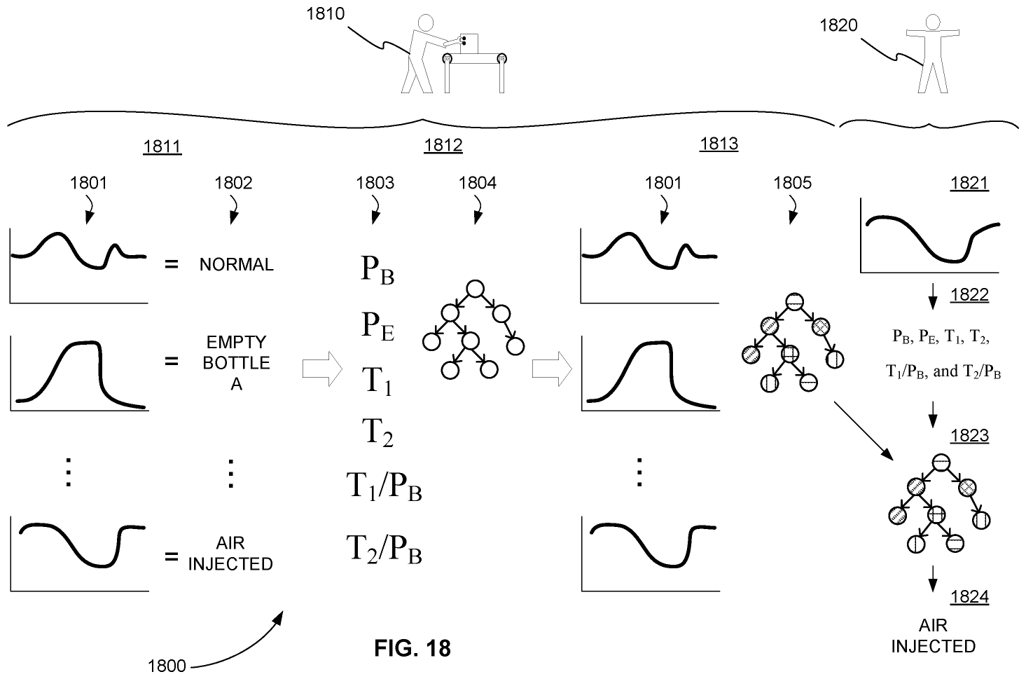

FIG. 18 is an exemplary diagram 1800 showing how a machine learning model is created and used, in accordance with various embodiments. First, vendor/manufacturer 1810 of an LC or mass spectrometry system performs a number of steps. For example, in step 1811, vendor/manufacturer 1810 gathers known data 1801 that covers known examples of outcomes 1802 that need to be classified. Further, not shown, vendor/manufacturer 1810 can prepare data 1801 by converting data 1801 to a common format, removing outliers, and splitting the data for training vs testing.

In step 1812, vendor/manufacturer 1810 finds model parameters 1803 from data 1801 that optimally classify data 1801 and creates parameters 1803 and model 1804 that translates parameters 1803 to outcomes 1802. Model 1804 is created using a machine learning algorithm, for example. In step 1813, vendor/manufacturer 1810 trains model 1804 with data 1801 in order to find the thresholds for model 1804. This training produces trained model 1805. The training involves finding threshold values for parameters 1803 of model 1805 that produce outcomes 1802. Model 1805 is produced by training model 1804 with data 1801 and other known data. Further, (not shown) vendor/manufacturer 1810 can measure the performance of model 1805 using additional test data.

An end user or customer 1820 of an LC or LC-MS system uses model 1805 to determine an outcome or operational condition of an LC system. For example, in step 1821, the system obtains sample data. In step 1822, the system calculates parameter values from the sample data. In step 1823, the system enters the calculated parameter values into model 1805 to obtain an outcome for the sample data. Finally, in step 1824, the system notifies user or customer 1820 of the outcome generated by model 1805.

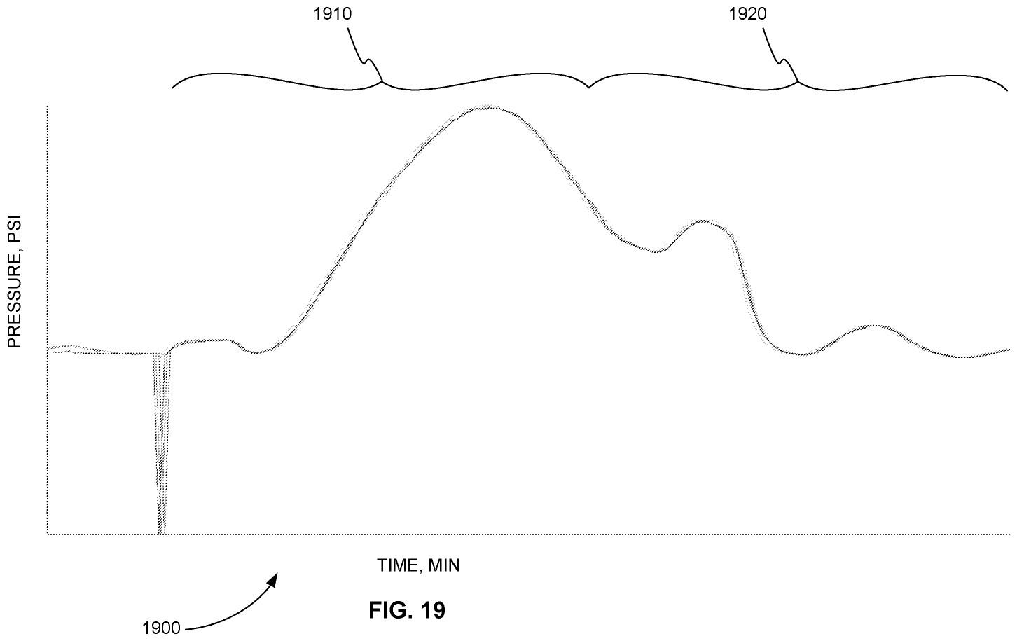

FIG. 19 is an exemplary plot 1900 of a pressure trace produced during an LC-MS/MS experiment in which the operational condition of the LC system was determined using a machine learning model, in accordance with various embodiments. FIG. 19 includes five different pressure traces corresponding to five different sample injections, for example. All of these pressure traces, however, have the same shape.

For each of the five traces, values for measurement parameters P_{B}, P_{E}, T₁, T₂, T₁/P_{B}, and T₂/P_{B} are calculated and provided as input to the machine learning model. Each average pressure (T₁) is calculated for first half 1910 of the separation, and each average pressure (T₂) is calculated for second half 1920 of the separation. For each of the five traces, the machine learning model produces a classification of the operational condition. The classification of these five traces is reversed A and B bottles. An indicator of the classification is then displayed on a display device for the user of the LC system.

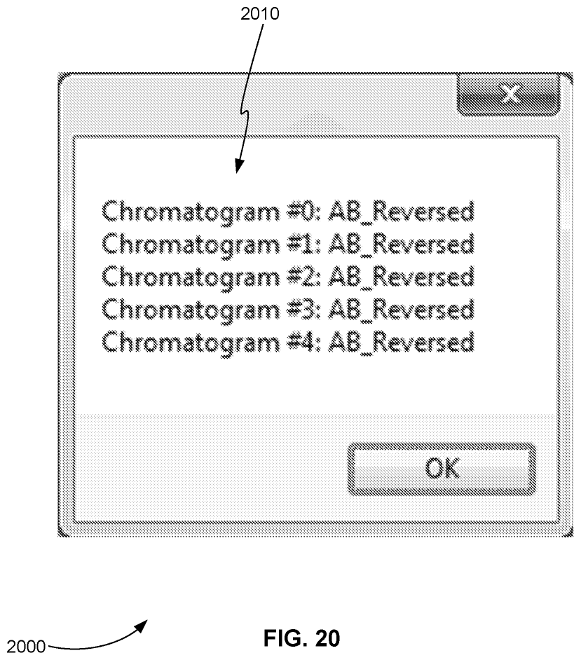

FIG. 20 is an exemplary display window 2000 of a display device showing the operational conditions found for the five pressure traces of FIG. 19, in accordance with various embodiments. In FIG. 20, the five indicators of the classification of the operational conditions are the five text messages 2010. These five text messages 2010 describe that the operational condition found for each trace is reversed A and B bottles.

### LC Apparatus for Detecting and Displaying an Operational Condition

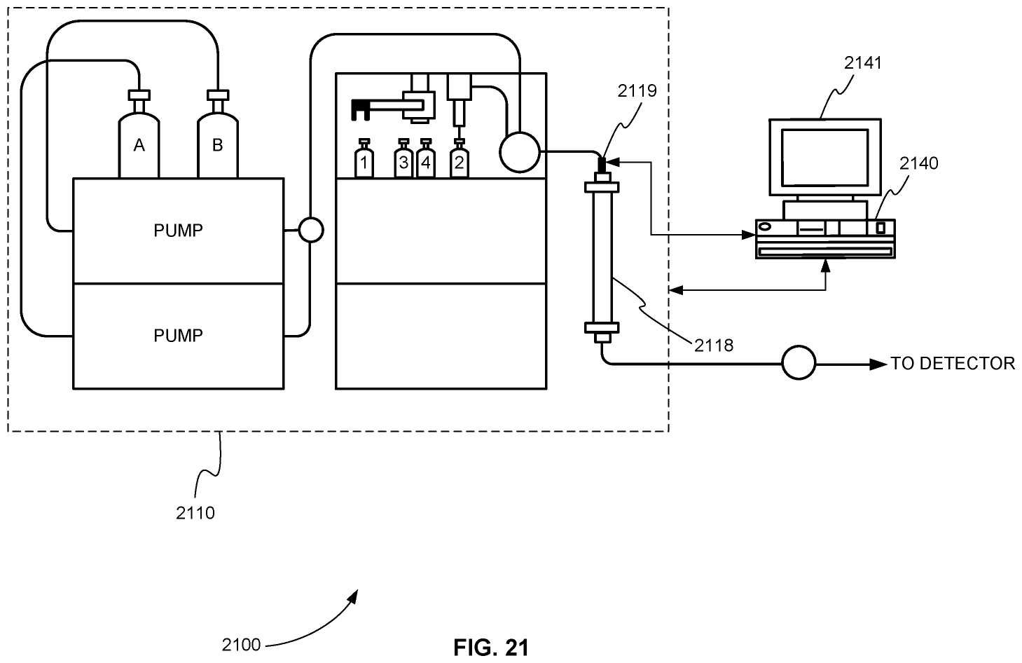

FIG. 21 is a schematic diagram 2100 of apparatus for detecting and displaying an operational condition of an LC system without user intervention, in accordance with various embodiments. The apparatus includes LC column 2118, pressure sensor 2119, display device 2141, and processor 2140.

LC column 2118 of LC system 2110 receives a mobile phase solution and performs a separation of one or more compounds from a sample of the mobile phase solution over time. Pressure sensor 2119 of LC system 2110 measures a pressure of the mobile phase solution in LC column 2118 over time, producing a plurality of pressure measurements over time.

Pressure sensor 2119 can be located in-line before LC column 2118, as shown in FIG. 21. In various alternative embodiments, pressure sensor 2119 can be located anywhere in the liquid pathway of the mobile phase solution before LC column 2118 or in a pump providing pressure to LC column 2118.

Processor 2140 receives the plurality of pressure measurements over time from pressure sensor 2119. Processor 2140 calculates values for one or more of six parameters from the plurality of pressure measurements over time. The six parameters include P_{B}, P_{E}, T₁, T₂, T₁/P_{B}, and T₂/P_{B}. Processor 2140 classifies the values of one or more of the six parameters as one of one or more operational conditions of LC system 210 using a machine learning model. The one or more operational conditions of LC system 210 can include, but are not limited to, normal operation with no LC equipment setup issues, an empty solvent bottle A, an empty solvent bottle B, reversed bottles A and B, a fitting failure, and air injected during sample injection.

The machine learning model is created from values of the one or more of the six parameters calculated from each separation of a plurality of known separations for each of the one or more operational conditions. The machine learning model is created using a machine learning algorithm. The machine learning model is created using standard techniques such as training and test data sets. The machine learning model is the set of parameters specific to a particular machine learning algorithm that can achieve an optimal classification of results. In various embodiments, the machine learning algorithm uses a support vector machine (SVM) algorithm or a decision tree algorithm to create the machine learning model.

Finally, processor 2140 displays on display device 2141 an indicator of the classification of the values as one of the one or more operational conditions. Processor 2140 can be a separate device as shown in FIG. 21 or can be a processor or controller of LC system 2110 or of a mass spectrometer used. Processor 2140 can be, but is not limited to, a controller, a computer, a microprocessor, the computer system of FIG. 1, or any device capable of sending and receiving control signals and data and capable of analyzing data. Similarly, display device 2141 can be a display of processor 2140 as shown in FIG. 21. In various alternative embodiments, display device 2141 can be a display of LC system 2110 or of a mass spectrometer used.

### LC Method for Detecting and Displaying an Operational Condition

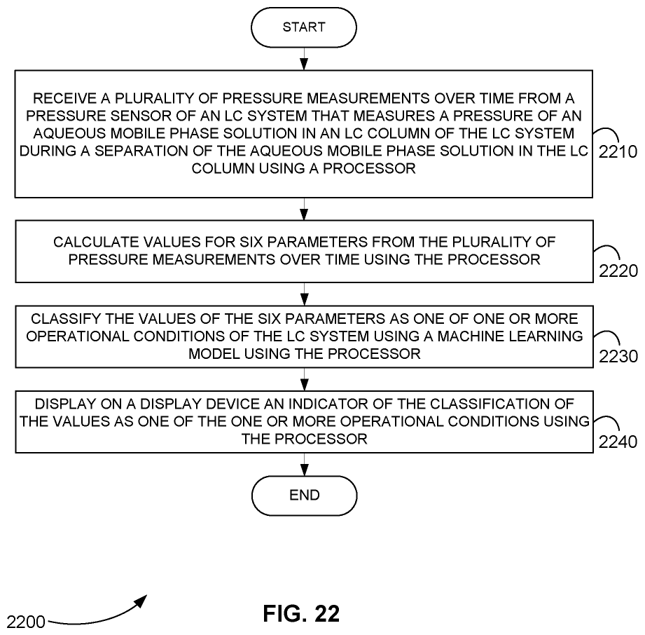

FIG. 22 is a flowchart 2200 showing a method for detecting and displaying an operational condition of an LC system without user intervention, in accordance with various embodiments.

In step 2210 of method 2200, a plurality of pressure measurements over time is received from a pressure sensor of an LC system using a processor. The pressure sensor measures a pressure of a mobile phase solution in an LC column of the LC system during a separation of the mobile phase solution in the LC column.

In step 2220, values are calculated for six parameters from the plurality of pressure measurements over time using the processor. The six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B}.

In step 2230, the values of one or more of the six parameters are classified as one of one or more operational conditions of the LC system using a machine learning model using the processor. The machine learning model is created from values of the one or more of the six parameters calculated from each separation of a plurality of known separations for each of the one or more operational conditions.

In step 2240, an indicator of the classification of the values as one of the one or more operational conditions is displayed on a display device using the processor.

### LC Computer Program Product for Detecting and Displaying an Operational Condition

In various embodiments, computer program products include a tangible computer-readable storage medium whose contents include a program with instructions being executed on a processor so as to perform a method for detecting and displaying an operational condition of an LC system without user intervention. This method is performed by a system that includes one or more distinct software modules.

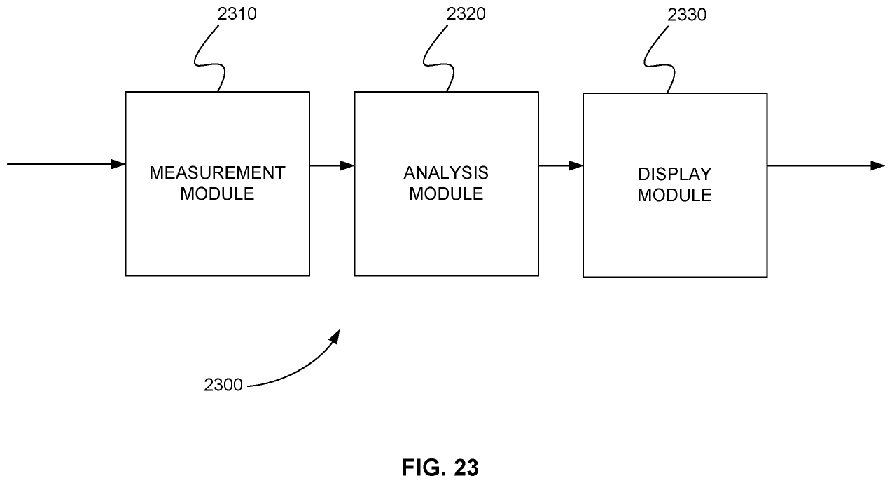

FIG. 23 is a schematic diagram of a system 2300 that includes one or more distinct software modules that perform a method for detecting and displaying an operational condition of an LC system without user intervention, in accordance with various embodiments. System 2300 includes a measurement module 2310, an analysis module 2320, and a display module 2330.

Measurement module 2310 receives a plurality of pressure measurements over time from a pressure sensor of an LC system. The pressure sensor measures a pressure of a mobile phase solution in an LC column of the LC system during a separation of the mobile phase solution in the LC column.

Analysis module 2320 calculates values for one or more of six parameters from the plurality of pressure measurements over time using the analysis module. The six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B}. Analysis module 2320 classifies the values of one or more of the six parameters as one of one or more operational conditions of the LC system using a machine learning model. The machine learning model is created from values of the one or more of the six parameters calculated from each separation of a plurality of known separations for each of the one or more operational conditions.

Display module 2330 displays on a display device an indicator of the classification of the values as one of the one or more operational conditions.

### Detecting and Displaying an Operational Condition from MRM Data

As described above, in an SRM or MRM scan, at least one precursor ion and product ion pair is known in advance. The mass filter of a mass spectrometer selects the one precursor ion. The collision cell of the mass spectrometer fragments the precursor ion. However, only product ions with the m/z of the product ion of the precursor ion and product ion pair are selected and mass analyzed using a mass analyzer of the mass spectrometer, producing an intensity for the product ion of the precursor ion and product ion pair. In other words, only one product ion is monitored.

In various embodiments, a mass spectrometer and MRM scans of an LC solvent composition (amount of water or organic) over time are used to detect and display an operational condition of an LC system without user intervention. In the most common mode of operation, LC systems rely on a constant flow rate. This generates a certain pressure on the LC column depending on the solvent composition. As a result, the LC column pressure is directly proportional to the solvent composition. Consequently, the LC column pressure can also be monitored by monitoring the solvent composition.

In various embodiments, an MRM for the solvent composition is scanned along with sample MRMs to detect an operational condition of the LC system.

### LC-MS Apparatus for Detecting and Displaying an Operational Condition

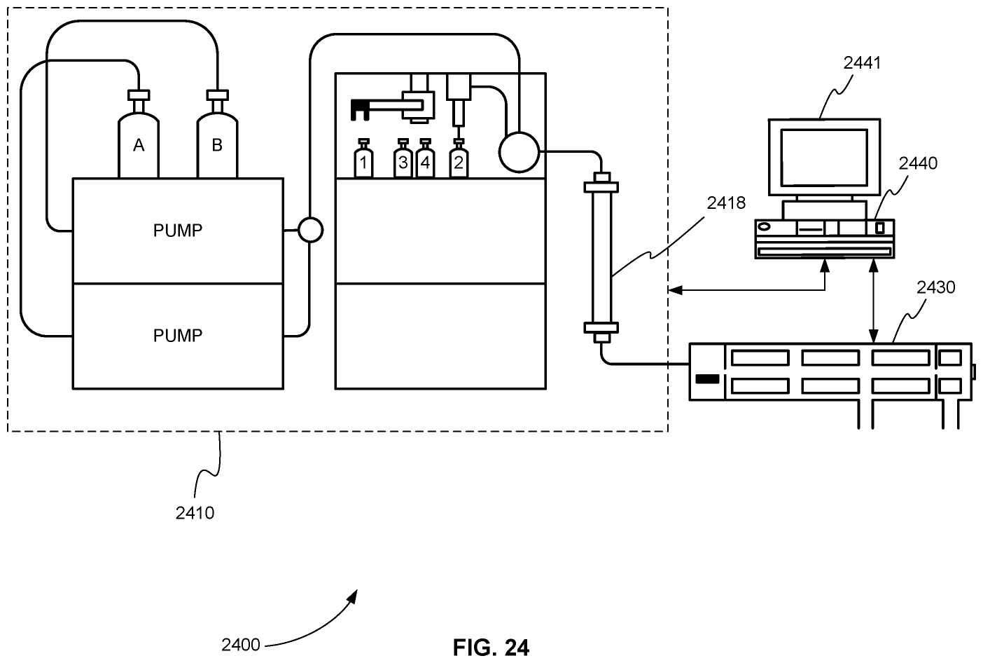

FIG. 24 is a schematic diagram 2400 of LC-MS apparatus for detecting and displaying an operational condition of an LC system without user intervention, in accordance with various embodiments. The apparatus includes LC column 2418 of LC system 2410, mass spectrometer 2430, display device 2441, and processor 2440.

LC column 2418 of LC system 2410 receives a mobile phase solution and performs a separation of one or more compounds from a sample of the mobile phase solution over time.

Mass spectrometer 2430 is a tandem mass spectrometer, for example. Mass spectrometer 2430 can include one or more physical mass analyzers that perform one or more mass analyses. A mass analyzer of a tandem mass spectrometer can include, but is not limited to, a time-of-flight (TOF), quadrupole, an ion trap, a linear ion trap, an orbitrap, a magnetic four-sector mass analyzer, a hybrid quadrupole time-of-flight (Q-TOF) mass analyzer, or a Fourier transform mass analyzer. Mass spectrometer 2430 can include separate mass spectrometry stages or steps in space or time, respectively.

Mass spectrometer 2430 measures intensities for at least one solvent composition of the LC system over time, producing at least one XIC for the at least one solvent composition. The at least one solvent composition can include water or an organic solvent. Organic solvents include, but are not limited to, methanol and acetonitrile.

Processor 2140 receives the plurality of pressure measurements over time from pressure sensor 2119. Processor 2140 calculates values for one or more of six parameters from the plurality of pressure measurements over time. The six parameters include P_{B}, P_{E}, T₁, T₂, T₁/P_{B}, and T₂/P_{B}. Processor 2140 classifies the values of one or more of the six parameters as one of one or more operational conditions of LC system 210 using a machine learning model. The one or more operational conditions of LC system 210 can include, but are not limited to, normal operation with no LC equipment setup issues, an empty solvent bottle A, an empty solvent bottle B, reversed bottles A and B, a fitting failure, and air injected during sample injection.

Processor 2440 receives the at least one XIC from the mass spectrometer 2430. Processor 2440 calculates values for one or more of six parameters from the one or more XICs. The six parameters include I_{B}, I_{E}, A₁, A₂, A₁/I_{B}, and A₂/P_{B}. Processor 2440 classifies the values of one or more of the six parameters as one of one or more operational conditions of LC system 2410 using a machine learning model. The one or more operational conditions of LC system 2410 can include, but are not limited to, normal operation with no LC equipment setup issues, an empty solvent bottle A, an empty solvent bottle B, reversed bottles A and B, a fitting failure, and air injected during sample injection.

The machine learning model is created from values of the one or more of the six parameters calculated from each separation of a plurality of known separations for each of the one or more operational conditions. The machine learning model is created using a machine learning algorithm. The machine learning model is created using standard techniques such as training and test data sets. The machine learning model is the set of parameters specific to a particular machine learning algorithm that can achieve an optimal classification of results. In various embodiments, the machine learning algorithm uses a support vector machine (SVM) algorithm or a decision tree algorithm to create the machine learning model.

Finally, Processor 2440 displays on display device 2441 an indicator of the classification of the values as one of the one or more operational conditions. Processor 2440 can be a separate device as shown in FIG. 24 or can be a processor or controller of LC system 2410 or of mass spectrometer 2430. Processor 2440 can be, but is not limited to, a controller, a computer, a microprocessor, the computer system of FIG. 1, or any device capable of sending and receiving control signals and data and capable of analyzing data. Similarly, display device 2441 can be a display of processor 2440 as shown in FIG. 24. In various alternative embodiments, display device 2441 can be a display of LC system 2410 or of mass spectrometer 2430.

### LC-MS Method for Detecting and Displaying an Operational Condition

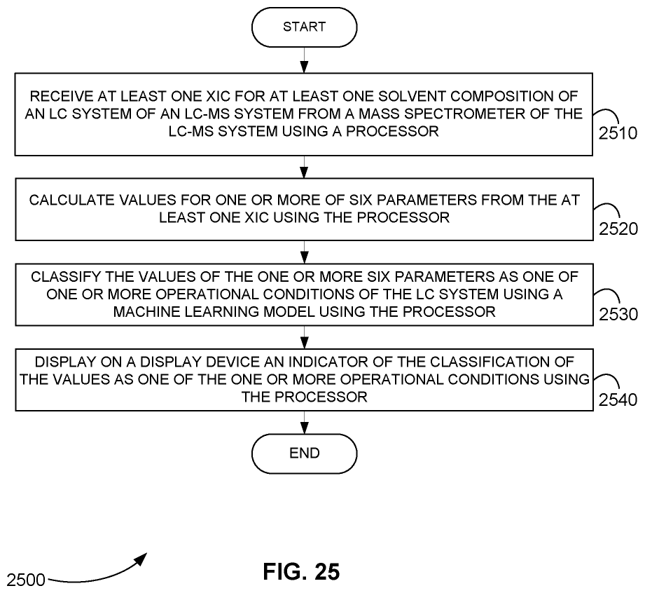

FIG. 25 is a flowchart 2500 showing a method for detecting and displaying an operational condition of an LC system of and an LC-MS system without user intervention, in accordance with various embodiments.

In step 2510 of method 2500, at least one XIC for at least one solvent composition of an LC system of an LC-MS system is received from a mass spectrometer of the LC-MS system using a processor. An LC column of the LC system receives a mobile phase solution and performs a separation of one or more compounds from a sample of the mobile phase solution over time. The mass spectrometer measures intensities for the at least one solvent composition of the LC system over time, producing the at least one XIC for the at least one solvent composition.

In step 2520, values for one or more of six parameters from the at least one XIC are calculated using the processor. The six parameters include a beginning intensity (I_{B}), an ending intensity (I_{E}), an average intensity (A₁) for a first half of the separation, an average intensity (A₂) for a second half of the separation, a ratio A₁/I_{B}, and a ratio A₂/I_{B}.

In step 2530, the values of the one or more of the six parameters are classified as one of one or more operational conditions of the LC system using a machine learning model using the processor. The model is created from values of the one or more of the six parameters calculated from each separation of a plurality of known separations for each of the one or more operational conditions.

In step 2540, an indicator of the classification of the values as one of the one or more operational conditions is displayed on a display device using the processor.

### LC-MS Computer Program Product for Detecting and Displaying an Operational Condition

In various embodiments, computer program products include a tangible computer-readable storage medium whose contents include a program with instructions being executed on a processor so as to perform a method for detecting and displaying an operational condition of an LC system of and an LC-MS system without user intervention. This method is performed by a system that includes one or more distinct software modules.

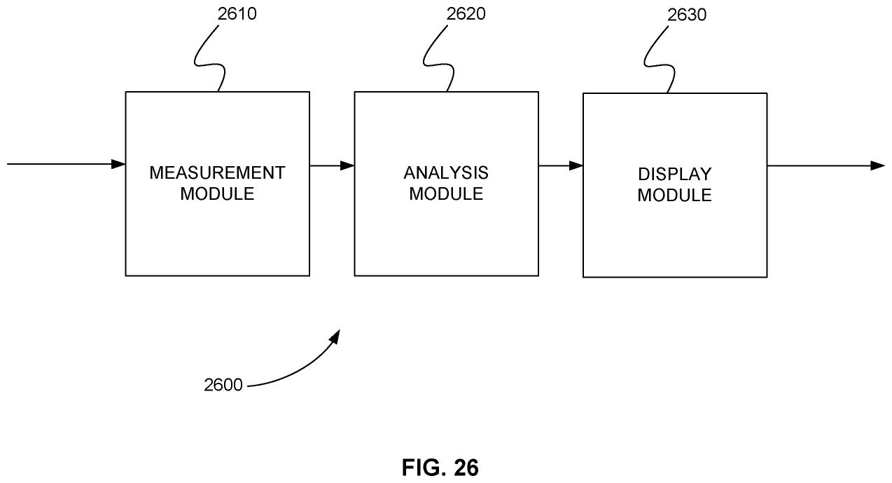

FIG. 26 is a schematic diagram of a system 2600 that includes one or more distinct software modules that perform a method for detecting and displaying an operational condition of an LC system of and an LC-MS system without user intervention, in accordance with various embodiments. System 2600 includes a measurement module 2610, an analysis module 2620, and a display module 2630.

Measurement module 2610 receives at least one XIC for at least one solvent composition of an LC system of an LC-MS system from a mass spectrometer of the LC-MS system. An LC column of the LC system receives a mobile phase solution and performs a separation of one or more compounds from a sample of the mobile phase solution over time. The mass spectrometer measures intensities for the at least one solvent composition of the LC system over time, producing the at least one XIC for the at least one solvent composition.

Analysis module 2620 calculates values for one or more of six parameters from the at least one XIC. The six parameters include a beginning intensity (I_{B}), an ending intensity (I_{E}), an average intensity (A₁) for a first half of the separation, an average intensity (A₂) for a second half of the separation, a ratio A₁/I_{B}, and a ratio A₂/I_{B}.

Analysis module 2620 classifies the values of the one or more of the six parameters as one of one or more operational conditions of the LC system using a machine learning model. The model is created from values of the one or more of the six parameters calculated from each separation of a plurality of known separations for each of the one or more operational conditions.

Display module 2630 displays on a display device an indicator of the classification of the values as one of the one or more operational conditions.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. Apparatus for detecting and displaying an operational condition of a liquid chromatography (LC) system without user intervention, comprising:
an LC column of an LC system that receives a mobile phase solution and performs a separation of one or more compounds from a sample of the mobile phase solution over time;
a pressure sensor of the LC system that measures a pressure of the mobile phase solution in the LC column over time, producing a plurality of pressure measurements over time;
a display device; and
a processor that
receives the plurality of pressure measurements over time from the pressure sensor,
calculates values for one or more of six parameters from the plurality of pressure measurements over time, wherein the six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B},
classifies the values of the one or more of the six parameters as one of one or more operational conditions of the LC system using a machine learning model, wherein the model is created from values of the one or more of the six parameters calculated from each separation of a plurality of known separations for each of the one or more operational conditions, and
displays on the display device an indicator of the classification of the values as one of the one or more operational conditions.

2. The apparatus of claim 1, wherein the one or more operational conditions comprise normal operation with no LC equipment setup issues.

3. The apparatus of claim 1, wherein the one or more operational conditions comprise an empty solvent bottle A.

4. The apparatus of claim 1, wherein the one or more operational conditions comprise an empty solvent bottle B.

5. The apparatus of claim 1, wherein the one or more operational conditions comprise reversed bottles A and B.

6. The apparatus of claim 1, wherein the one or more operational conditions comprise a fitting failure.

7. The apparatus of claim 1, wherein the one or more operational conditions comprise air injected during sample injection.

8. The apparatus of claim 1, wherein the pressure sensor is located in-line before the LC column.

9. The apparatus of claim 1, wherein the pressure sensor is located in a pump providing pressure to the LC column.

10. The apparatus of claim 1, wherein the machine learning model is created using a machine learning algorithm.

11. The apparatus of claim 10, wherein the machine learning algorithm comprises a support vector machine (SVM) algorithm.

12. The apparatus of claim 10, wherein the machine learning algorithm comprises a decision tree algorithm.

13. The apparatus of claim 1, wherein the processor calculates values for all six of the one or more of six parameters from the plurality of pressure measurements over time.

14. A method for detecting and displaying an operational condition of a liquid chromatography (LC) system without user intervention, comprising:
receiving a plurality of pressure measurements over time from a pressure sensor of an LC system that measures a pressure of a mobile phase solution in an LC column of the LC system during a separation of the mobile phase solution in the LC column using a processor;
calculating values for one or more of six parameters from the plurality of pressure measurements over time using the processor, wherein the six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B};
classifying the values of the one or more of the six parameters as one of one or more operational conditions of the LC system using a machine learning model using the processor, wherein the model is created from values of the one or more of the six parameters calculated from each separation of a plurality of known separations for each of the one or more operational conditions, and
displaying on a display device an indicator of the classification of the values as one of the one or more operational conditions using the processor.

15. A computer program product, comprising a non-transitory and tangible computer-readable storage medium whose contents include a program with instructions being executed on a processor to perform a method for detecting and displaying an operational condition of a liquid chromatography (LC) system without user intervention, the method comprising:
providing a system, wherein the system comprises one or more distinct software modules, and wherein the distinct software modules comprise a measurement module, an analysis module, and a display module;
receiving a plurality of pressure measurements over time from a pressure sensor of an LC system that measures a pressure of a mobile phase solution in an LC column of the LC system during a separation of the mobile phase solution in the LC column using the measurement module;
calculating values for one or more of six parameters from the plurality of pressure measurements over time using the analysis module, wherein the six parameters include a beginning pressure (P_{B}), an ending pressure (P_{E}), an average pressure (T₁) for a first half of the separation, an average pressure (T₂) for a second half of the separation, a ratio T₁/P_{B}, and a ratio T₂/P_{B};
classifying the values of the one or more of the six parameters as one of one or more operational conditions of the LC system using a machine learning model using the analysis module, wherein the model is created from values of the one or more of the six parameters calculated from each separation of a plurality of known separations for each of the one or more operational conditions, and
displaying on a display device an indicator of the classification of the values as one of the one or more operational conditions using the display module.

16-30. (canceled)
